(19) United States
(12) Patent Application Publication
(10) Pub. No.: US 2003/0078816 A1
(43) Pub. Date: Apr. 24, 2003

(54) System and method for collaborative insurance claim processing

(76) Inventor: Thomas J. Filep, Bedminster, NJ (US)

Correspondence Address: William D. Wiese, Jenkens & Gilchrsit, A Professional Corporation, Suite 3200, 1445 Ross Avenue, Dallas, TX, 75202, US

(21) Appl. No.: 10/256,367

(22) Filed: Sep. 27, 2002

Related U.S. Application Data
(60) Provisional application No. 60/325,219, filed on Sep. 28, 2001.

(51) Int. Cl. G06F 17/60; G06F 7/00; G06F 17/00

(52) U.S. Cl. 705/4; 707/104.1; 705/35

(57) ABSTRACT

A system for collaboratively managing complex, longtail property and casualty insurance claims which is remotely and continuously accessible by all users designated by the insurer. The users can access documents retained in a centralized database through an application layer. The application layer includes a workflow application, a document management application and an administrative application. A method for collaboratively managing complex claims includes the storage of documents in a centralized remotely-accessible computer database, access to the documents through an application layer, and management of the claim management process through a workflow management application used in connection with a document management application.

### PRIORITY STATEMENT UNDER 35 U.S.C. §119 & 37 C.F.R. §1.78

This non-provisional application claims priority based upon prior U.S. Provisional Patent Application Serial No. 60/325,219 filed Sep. 28, 2001 in the name of Thomas J. Filep, entitled “Provisional Business Requirements Document.”

### BACKGROUND OF THE INVENTION

1. Technical Field of the Invention

The present invention relates generally to a system and method for processing claims within the property and casualty insurance industries. More particularly, the present invention relates to a comprehensive, collaborative system and method for processing insurance claims, including a method for managing the workflow associated with such claims, providing a repository for information and documents relating to the claim, and providing a means for real-time collaboration regarding the claim workflow process.

2. Description of Related Art

When an insurer processes a claim, it performs a discrete number of related tasks and these tasks are, in general, the same from claim to claim. For example, when a claim is submitted, the insurer will typically receive a first loss notice from the insurance broker. The claim clerk will review the notice to make certain that it is complete and forward it to the supervisor. The supervisor will review the file for compliance and the claim support unit will construct a paper file with policy identifying information. The claim support unit will refer the paper file to the claim handler. The claim handler receives the assignment, verifies the coverage, and, thereafter, the underwriter refers policy documents to the claim handler. The claim handler develops a coverage analysis, damages evaluation and a disposition plan. If the claim is involved in litigation, the file will be forwarded to defense counsel. Defense counsel will add additional documents to the file, such as interrogatories, court filings and the like, and may involve an outside investigator who may submit their own reports. Once the claim is complete, the claim handler will close the file and send it to storage.

Existing methods and systems for processing claims within the insurance industry are typically limited to only a few of these tasks. In particular, existing methods and procedures are not well suited to extended, complex longtail insurance claims, the processing of which may occur over a two- to twenty-year period, since they only handle a small portion of the tasks necessary to complete the process. There is a need, therefore, for a centralized, online, method and system for initiating, monitoring, maintaining and completing the complex claim workflow process.

Existing methods for managing the claim workflow process are typically further limited in their use, largely because there is no means for centralized access to the information. For example, if the document repository described in the foregoing description of workflow is limited to those documents created in the claims department, the claim handler may not have access to documents generated in the legal department. An added complication of this system is that the file may change hands a number of times through the process and, in each case, there is a possibility that documents will be lost from the file, that documents already existing in the file will be added redundantly. Moreover, once each department has no further use for the file, files are typically stored offsite, resulting in a fragmented collection of file remnants in the event the file needs to be subsequently recreated.

Existing methods for managing the claim workflow process are typically further limited in their use, largely because each of the parties assisting in the process utilizes a different system for managing their workflow. In many cases the workflow systems used by different parties are inconsistent or incompatible. For example, the management system used by the insurer's counsel may have been selected by the law firm based on its ability to manage legal projects whereas it may not be compatible in any manner with the insurer's computerized workflow system. This leads to a duplicative multiplicity of documents, files and messages. In addition, because each party does not have access to the same file, and therefore the same documents within the file, it may be difficult for the parties to communicate regarding the claim.

Existing methods for managing the claim workflow process also fail to incorporate a means by which the return on investment can be accurately determined. To date, there has not been a user-friendly software product that provides a rapid and verifiable return on investment achievable with minimal business interruption. As the insurance industry becomes increasingly competitive, the need grows for an efficient means for estimating and immediately verifying a projected return on investment. There is a need, therefore, for an improved system and method for assessing the return on investment resulting from the insurer's use of the improved system and method on a real-time basis.

### SUMMARY OF THE INVENTION

The present invention addresses the need for a centralized, online, system and method for initiating, monitoring, maintaining and completing the complex claim workflow process. The present invention provides for a method for collaboratively managing insurance claim processing in which the parties involved in the claim management process have access to a centralized computer database through an application layer. The application layer contains a document management application and a workflow management application. The centralized computer database contains documents relating to the insurance claim being processed. Access to the centralized computer database, the document management application and the workflow management application are all on a real-time basis.

The present invention also provides a system for collaboratively managing an insurance claim consisting of a centralized remotely accessible database consisting of document relating to the claim; an application layer that consists of a workflow management application, a document management application, an administration application and access to the database; and a method for accessing the database through the application layer.

The present invention also provides an improved method for predicting and verifying the return on investment that is achieved through the implementation of the system and method for collaborative insurance claim processing.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a flow diagram showing the typical task workflow in the claim management process;

FIG. 2 is a general flow diagram showing the preferred method for insurance claim processing;

FIG. 3 is a diagram of the preferred system for managing the claim workflow process;

FIG. 4 is a diagram of the preferred system for the workflow management application shown in FIG. 3;

FIG. 5 is preferred screen from a graphical user interface for the document repository shown in FIG. 3;

FIG. 6 is a preferred screen from a graphical user interface for the progress view shown in FIG. 4;

FIG. 7 is another preferred screen from a graphical user interface for the progress view shown in FIG. 4;

FIG. 8 is a preferred screen from a graphical user interface for the project view shown in FIG. 4;

FIG. 9 is a preferred screen from a graphical user interface for the collaborative view shown in FIG. 3; and

FIG. 10 is a preferred screen from a graphical user interface for the research view shown in FIG. 3.

### DETAILED DESCRIPTION OF THE EXEMPLARY EMBODIMENTS OF THE INVENTION

The numerous innovative teachings of the present application will be described with particular reference to the presently preferred exemplary embodiments. However, it should be understood that these embodiments provide only a few examples of the many advantageous uses of the innovative teachings herein. In general, statements made in the specification of the present application do not necessarily delimit any of the various claimed inventions. Moreover, some statements may apply to some inventive features, but not to others.

The present invention provides a new and improved method and system for collaboratively processing complex claims in the insurance industry. The present invention provides for a real-time, collaborative workflow process that allows all users with concurrent access to the workflow engine. Additionally, the system provides a method for managing the workflow associated with such claims, providing a repository for information and documents relating to the claim, and providing a means for real-time collaboration regarding the claim workflow process. The present invention provides a solution that is easily integrated with existing technology, products and systems

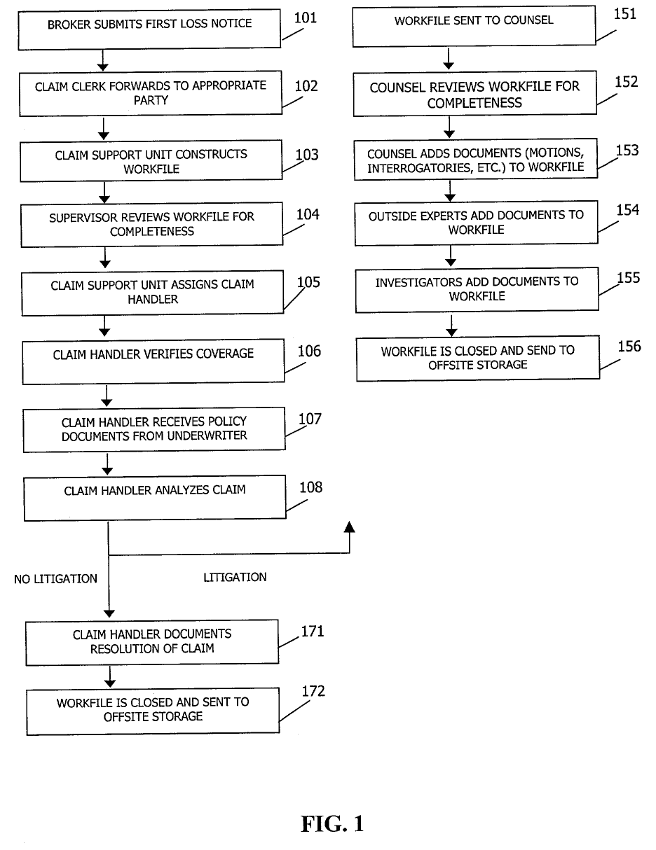

As shown in FIG. 1, a generic claim processing workflow is illustrated. The claim workflow shown in FIG. 1 is tailored specifically for property and casualty insurance claims. Other types of insurance, such as health or workers compensation insurance, may be mapped into similar claim workflow processes. Typically, a first loss notice is submitted by a broker 101 when the broker receives notice of a claim. The claim clerk will designate the claim to the appropriate party for handling 102. Once the notice has been designated by the claim clerk, a claim support unit will construct a paper work file 103 and a supervisor will review the work file and provide pre-assignment instructions 104. If the file is complete, the claim support unit will assign a claim handler 105 to handle the ensuing workflow process. The claim handler will initially verify coverage 106 and will subsequently receive policy documents from the underwriter 107.

Next, the claim handler will analyze the claim 108 and develop a coverage analysis, damages evaluation and a disposition plan. If the claim is involved in litigation at that time, or subsequently becomes involved in litigation, the work file will be sent to the insurer's counsel 151. Counsel will preliminarily review the work file for completion 152 and, thereafter, will continue to add documents and other communications, such as motions, interrogatories and other litigation-related documents, to the work file 153. In addition, counsel may retain outside experts who will be involved with the preparation of reports related to the claim. The experts will, from time-to-time, require access to the work file in order to review the claim history and to ascertain the current status of the claim.

Once the expert has completed his report, it will be added to the documents in the work file 154. In addition, investigators may be retained by counsel in order to investigate matters related to the claim. These investigators will also require access to the work file, from time-to-time, in order to evaluate certain matters related to the claim. Once the investigators complete their reports, those documents will also be added to the work file 155. It is anticipated in the preferred embodiment of the invention that additional parties may deposit additional documents into the work file, and may require access to the work file, from time-to-time. In addition, management information reports can be extracted to assess financial results of claim settlements. Also, the closed claim file is referred to a subrogation unit for recovery potential of claim payments. Once the claim has been fully and finally resolved, a process which may take many years, the work file is closed and may be sent to off-site storage 156.

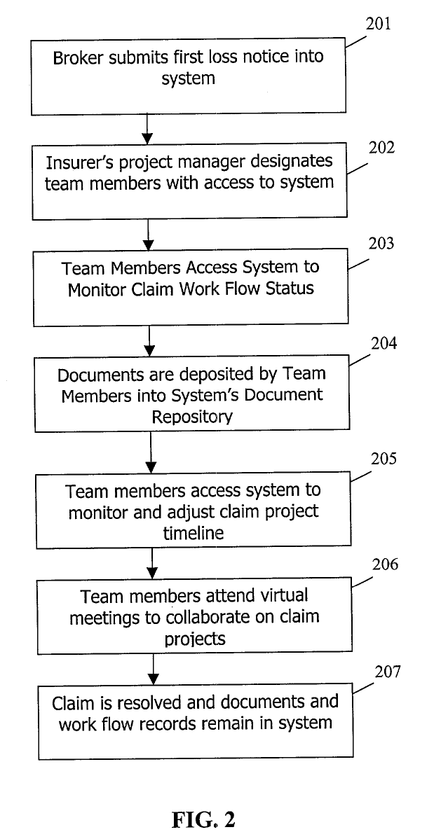

There are numerous deficiencies in the foregoing process. The present invention provides a novel collaborative method for insurance claim processing. A preferred method for processing insurance claims according to the invention is shown in FIG. 2. The method commences when a broker submits a first loss notice into the system 201. Once the first loss notice is received, the insurer's project manager designates end-user team members with access to the system 202. Team members may include claim handlers, supervisors, underwriters, counsel to the insurer, and other end users designated by the insurer. Team members need not be confined to a single office or company, nor need they be located in close geographical proximity. Moreover, team members may be added or deleted from time-to-time as the demands of the claim workflow process dictate. Once access to the system has been established for the team members, those members may begin working to resolve the claim. In doing so, team members may access the system 24 hours per day, from any location, securely and conveniently to monitor the claim workflow status 203. Because the system is accessible to all team members, each team member can see the current status of the project at any time on a real time basis.

During the claim workflow process, documents are deposited by team members into the system's document repository 204. For example, an executive may enter notes onto a digital personal assistant and then download those notes into the document repository 204. The document repository 204 is used to maintain all information associated with the claim and may be linked to the workflow process so that documents can easily be retrieved when needed. The document repository 204 permits documents to be checked in and checked out while maintaining a history of such activity. In addition, subsequent version of the document may be stored in the document repository 204.

Team members will also be able to access the system to monitor the project status and to adjust the claim completion timeline 205. This system also contains project information, progress information, current status information, threaded discussions and a listing of the documents in the document repository. As the project progresses, team members may attend virtual on-line meetings to collaborate on issues related to the claim 206. This feature of the preferred embodiment allows team members the ability to collaborate on all phases of the claim workflow process. Once the claim is resolved, documents and workflow records remain in the system 207. Team members will have continued access to the workflow documentation in the event such a need arises.

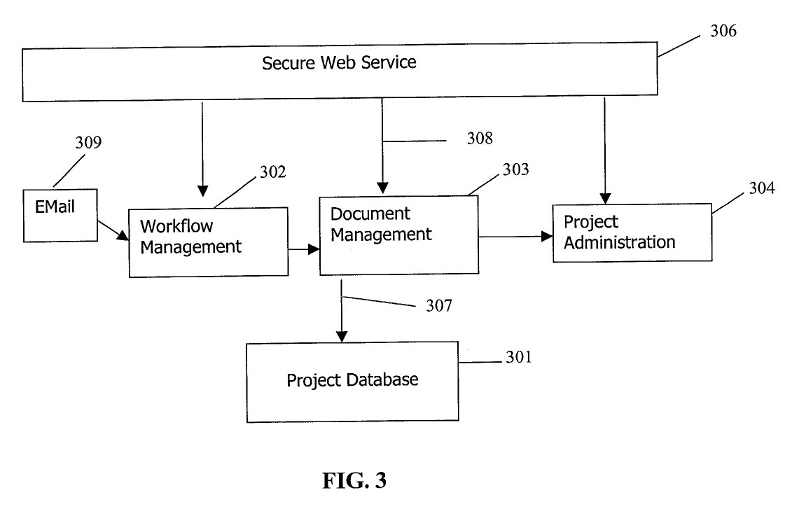

A system 300 for executing a preferred method of managing insurance claims processing is shown in FIG. 3. The system 300 preferably comprises a project database 301, an application layer 305, and a secure web service 306. All documents in this system reside in the project database 301 for security purposes and to ensure that there are not duplicate versions of documents used in the workflow process. Documents in the project database 301 are managed by the document management application 303. Team members will have the ability to upload and work on documents using the workflow application 302. When a team member completes work on a document in the project database 301, they will be able to forward an e-mail message within the application layer 305 to another team member notifying them of the project status and other necessary project information. Applications in the application layer 305 will have continuous access 307 to the project database 301. Team members will have access 308 to the application layer 305 through a secure web service 306. Each team member's access 308 to the application layer 305 will be secured by an industry standard lightweight directory access protocol (LDAP). In addition to the security provided by this protocol, team members will be allowed access to elements within the application layer 305 based on their entitlement to such access. The entire system may be administered through the project administration application 304.

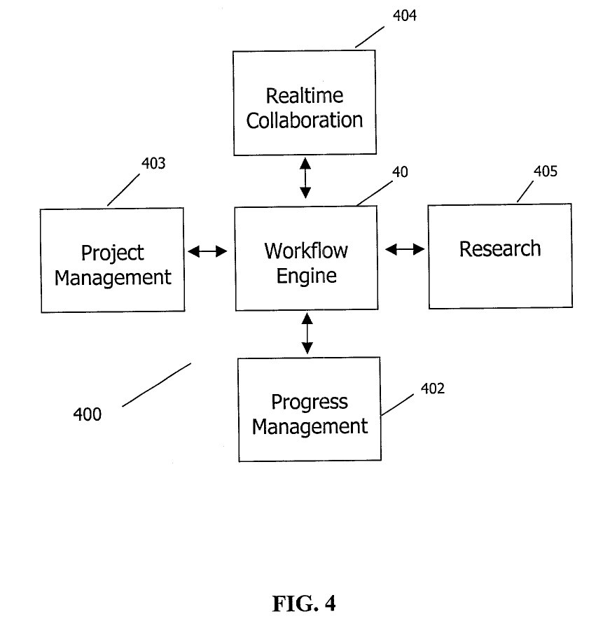

A system 400 for execution a preferred method of workflow management 302 is shown in FIG. 4. The workflow engine 401, which has access to the document management application 303, provides a means for managing the claims workflow process. Team members utilizing the workflow engine 401, may access the workflow management application 302 to obtain information regarding the claim workflow progress through the progress management application 402. In addition, team members may perform research 405 through the workflow engine 401 as well as engage in real time collaboration 404 and overall project management 403. The workflow management application may include the ability to translate documents from one language to another for ease of use among all users.

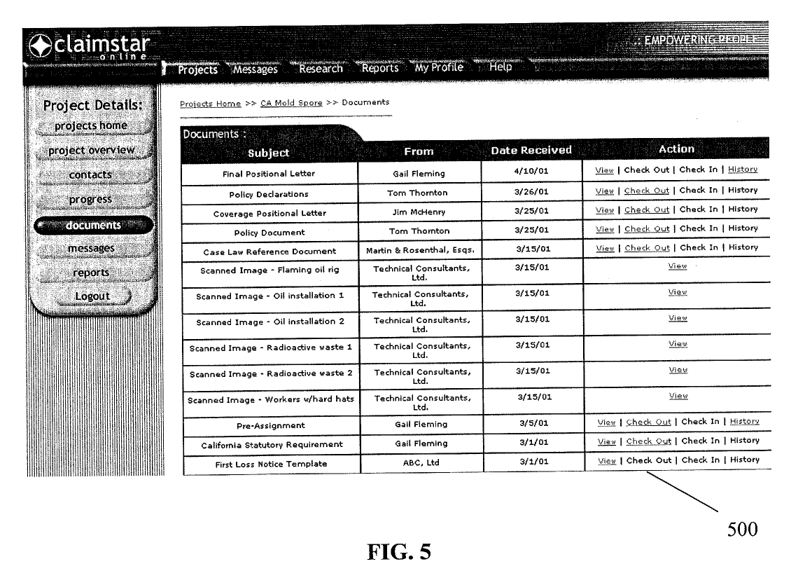

As illustrated in FIG. 5, a graphical user interface for use with the method and system of the present invention allows an authorized team member to view the documents available in the document repository. The graphical user interface not only permits a user to enter and retrieve documents from the document database, but also permits the user to execute tasks required in claims processing such as opening a specific claim data file, inputting information, and returning the document to the document repository. The graphical user interface may be constructed using software tools and languages commonly known in the art. In one embodiment, the graphical user interface 500 includes a sidebar containing a plurality of identifying elements representing the basic claim workflow process. Generally, identifying elements will include a project home, a project overview, contacts, progress, documents, messages, reports and log-out.

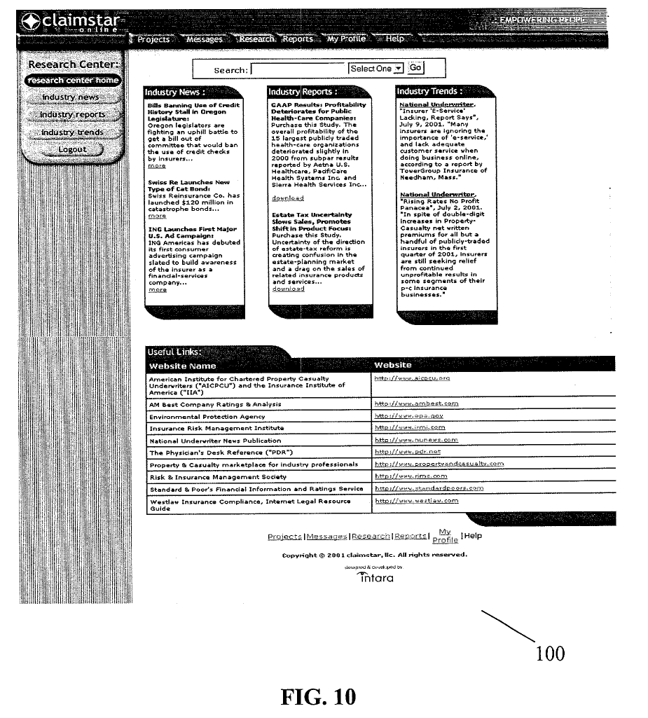

The graphical user interface 500 will also include a tool bar containing tabs that allow the user to choose from a plurality of features within the system, including projects, messages, research, reports, my profile and help. For example, if a user selects the research tab, they will access the graphical user interface for the research review as shown in FIG. 10.

The graphical user interface 500 will also contain a complete list of the documents contained in the document database. In the preferred embodiment of the system 500 shown in FIG. 5, each document is identified by subject, the party submitting the document, the date the document was received and action required with respect to the document.

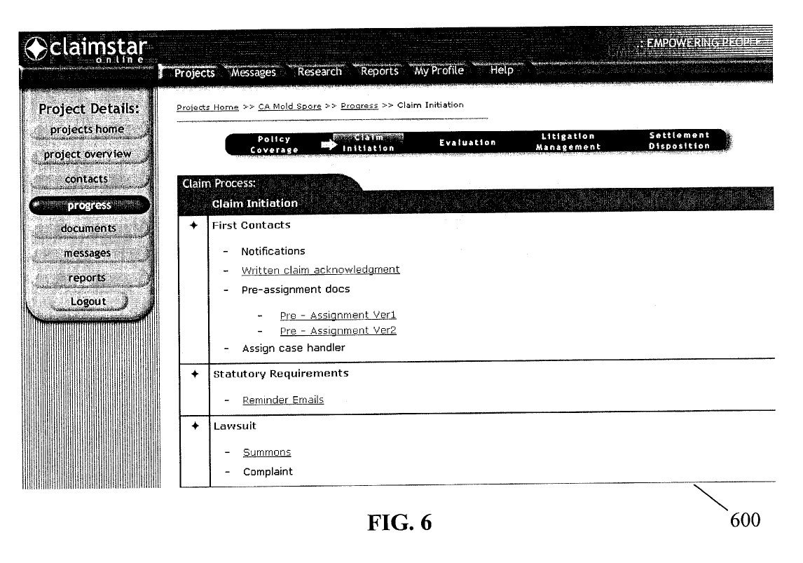

As illustrated in FIG. 6, a graphical user interface 600 for use with the method and system of the present invention allows an authorized team member to view the claim workflow progress. As with the previous graphical user interface 500, identifying elements are included in a sidebar indicating the project details. Also as indicated in the previous graphical user interface 500, a toolbar containing tabs a user can move between various locations within the system. In one embodiment of the graphical user interface 600, detailed information regarding the claim processes is presented. For example, in the graphical user interface 600 various steps within the claim initiation process are identified including a plurality of first contacts, statutory requirements and issues related to a lawsuit.

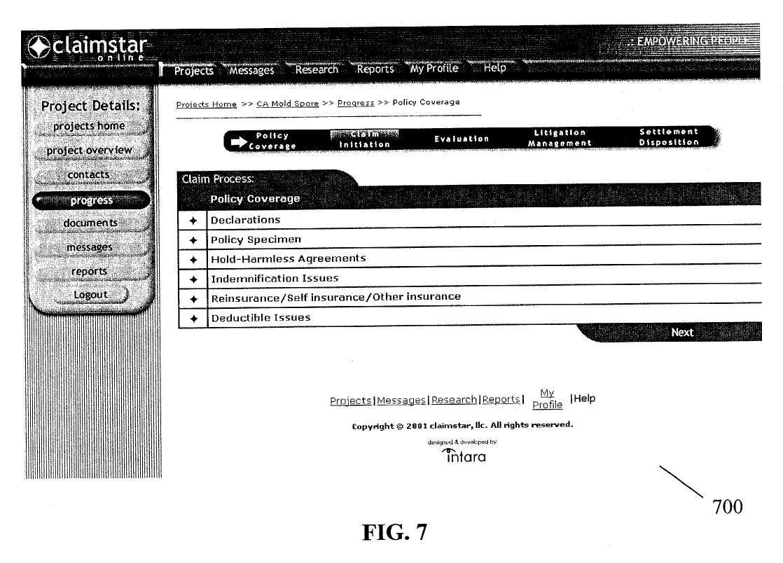

As illustrated in FIG. 7, a graphical user interface 700 for use with the system and method of the present invention also allows an authorized team member to view the claim workflow progress. The identifying elements in the sidebar as well as the toolbar containing tabs are again inherent in this graphical user interface. In this embodiment of the graphical user interface, when the user selects policy coverage, that user would be able to view information concerning the claim workflow process, such as the policy declarations, policy specimen, hold harmless agreements, indemnification issues, reinsurance/self-insurance/other insurance issues and deductible issues. The user can add relevant topic updates at any time. Those skilled in the art will understand that the reporting sections can be expanded beyond those provided in FIG. 7.

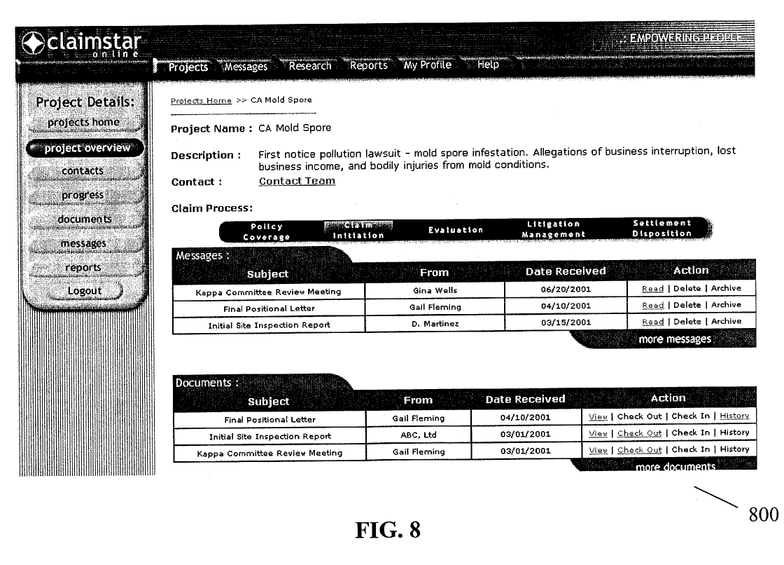

As illustrated in FIG. 8, a graphical user interface 800 for use with the method and system of the present invention allows the user to view the project overview of the claim workflow process. In the embodiment shown in FIG. 8, the graphical user interface 800 includes the project name, a description of the project, a contact or contact list, and an identification of the claim process. In this case, the claim process includes both a subset of messages and a subset of documents related to the particular project.

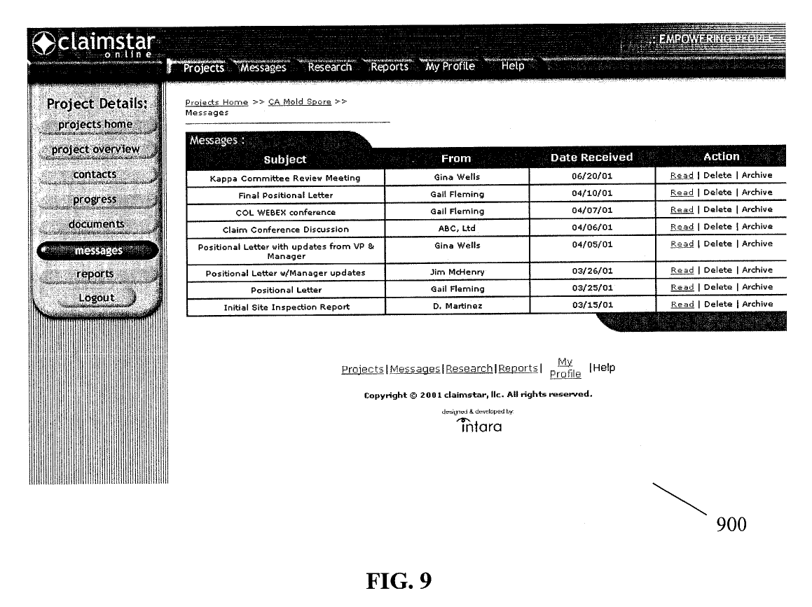

As illustrated in FIG. 9, a graphical user interface 900 for use with the method and system of the present invention allows an authorized team member to send and receive messages from other authorized team members. This feature provides a chronological order of all messages pertaining to a specific project. In graphical user interface 900 a list of messages is provided by subject, author, date received and action in which the user has the option of reading, deleting or archiving each message.

As illustrated in FIG. 10, a graphical user interface 1000 for use with the method and system of the present invention allows an authorized team member to perform research related to the current project. Using this functionality, the user can immediately access industry news, reports and trends to facilitate prompt, efficient risk management. In addition, authorized team members have direct access to a variety of pre-selected web sites.

The present invention also provides a novel method of predicting and subsequently verifying the return on investment actually achieved by the improved claim processing system. An analysis is first performed of the business operations of the potential user. Information is obtained concerning the relevant factors in performing the return on analysis calculation. In some instances, this information is obtained during a trail usage period. Information provided in the return on investment analysis includes anticipated savings through employee reductions, administrative costs, defense counsel fees, defense expert fees, vendor fees, field audit savings, file storage space reduction and telecommuting.

Operation

A more detailed description of the operation of the present invention begins with the step of providing parties involved in the claim management process with access to a centralized computer base, storing documents pertaining to the claim management process in the centralized computer data base, managing the documents in the computer data base through a document management application, providing access to the document management application and the centralized computer data base through a work flow management application, providing the parties with real time access to the computer data base, providing the parties with real time access to the document management application, and providing the parties with real time access to the work flow management application. The foregoing method may also be used where the parties are located remotely from the centralized computer data base. The foregoing method may also be used where the documents pertaining to the claim management process include data on a claim, data on a claim, data for an insured and data on the claim resolution process. The foregoing method also contemplates that the computer data base and the document management application are located remotely. The foregoing method also contemplates a centralized computer data base which is a relational data base. The foregoing method also contemplates the step of converting the document into formatted data files for ease of storage and transmission. The foregoing method also contemplates that the documents in the computer data base are signed electronically. In the foregoing method, the real time access to the computer data base can be accomplished through a secure encrypted transmission. In addition, the real time access to the centralized computer data base to the document management application and to the work flow management application can be accomplished over the Internet. The foregoing method also contemplates that real time access to the work flow management application may be accomplished by processing input by voice. The document management application in the foregoing system allows documents to be checked in and out, and also has the ability to add new versions of the same document and includes a version control feature. The foregoing method also contemplates that the work flow management application will include an adjustable claim completion time line. The work flow management application in the foregoing method may permit users to attend virtual online meetings and may permit users to send and receive e-mails within the work flow management application. In addition, the real time access to the work flow management application may be secured by light weight directory access protocol. The foregoing method also contemplates that access to the centralized computer data base may be based on an entitlement system. The work flow management application within the foregoing method may also provide a means for translating the documents within the centralized computer data base into a common language.

The foregoing method also contemplates that the work flow management application may comprise a means for accessing the document management application, a means for monitoring the process of the claim management process, a means for performing researching pertaining to the claim management process, a means for engaging in real time collaboration on issues pertaining to the claim management process and a means for managing the claim management process. The foregoing work flow management application may also include a means for accessing the document management application based on secure encrypted transmissions. The foregoing work management application may also provide a means for accessing the document management application over the Internet. The foregoing work flow management application may also include a means for monitoring the claim management system which includes real time information pertaining to the status of the documents in the centralized computer data base. The foregoing work flow management application may also include a means for performing research which includes real time access to the centralized computer data base. The document management application within the foregoing work flow management application may also provide a means for retaining commonly used forms within the claim management process.

The present invention includes a system for collaboratively managing an insurance claim which includes a centralized remotely accessible data base including documents pertaining to the insurance claim, an application layer, including a work flow management application, a document management application, an administration application and access to said centralized remotely accessible data base, and a means for parties involved in processing the insurance claim to remotely access the application layer. The foregoing system may also include a centralized remotely accessible data base as a relational data base. In addition, the documents in the foregoing system may include data on a claim, data on an insured and data on the claim resolution process. The foregoing system may also contain a centralized remotely accessible data base which is remotely accessible within a wide area network. The foregoing system may also include a means for converting the documents into formatted data files for ease of storage and transmission. The foregoing system may also include access to the centralized remotely accessible data base which is secure and encrypted or which is over the Internet. The work flow management application in the foregoing system may also provide a means for electronically signing documents.

The work flow management application in the foregoing system may also include a means for accessing the document management application, a means for monitoring the process of the overall claim management process, a means for performing research pertaining to the claim management process, a means for engaging in real time collaboration on issues pertaining to the claim management process and a means for managing the claim management process. The foregoing work flow management application may also contain a means for managing the progress of the overall claim management system which comprises real time information pertaining to the status of the documents in the computer data base.

Another facet of the present invention includes a method for verifying a projected return on investment which includes steps of analyzing the specific business operation of a potential user, determining the factors relevant to the calculation of the business' return on investment, calculating the return on investment based on the factors in the business operation, integrating the calculation into the claim processing system, monitoring the factors within the claim processing system, and verifying the calculation on a real time basis based on the changes to the factors.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

I claim:

1. A method for collaboratively managing insurance claim processing comprising the steps of:
providing parties involved in the claim management process with access to a centralized computer database;
storing documents pertaining to said claim management process in said centralized computer database;
managing said documents in said computer database through a document management application;
providing access to said document management application and said centralized computer database through a workflow management application;
providing said parties with real-time access to said computer database;
providing said parties with real-time access to said document management application; and
providing said parties with real-time access to said workflow management application.

2. The method of claim 1 wherein said parties are located remotely from said centralized computer database.

3. The method of claim 1 wherein said documents pertaining to said claim management process include data on a claim, data or an insured and data on the claim resolution process.

4. The method of claim 1 wherein said computer database and said document management application are located remotely.

5. The method of claim 1 wherein said centralized computer database is a relational database.

6. The method of claim 1 further comprising the step of converting said document into formatted data files for ease of storage and transmission.

7. The method of claim 1 wherein said documents in said computer database are signed electronically.

8. The method of claim 1 wherein said real-time access to said computer database is by secure, encrypted transmission.

9. The method of claim 1 wherein said real-time access to said centralized computer database is over the Internet.

10. The method of claim 1 wherein said real-time access to said document management application is over the Internet.

11. The method of claim 1 wherein said real-time access to said workflow management application is over the Internet.

12. The method of claim 1 wherein said real-time access to said workflow management application comprises a means for processing input by voice.

13. The method of claim 1 wherein said document management application includes the ability to check documents in and out.

14. The method of claim 1 wherein said document management system has the ability to add new versions of the same document and includes a version control feature.

15. The method of claim 1 wherein said workflow management application includes an adjustable claim completion timeline.

16. The method of claim 1 where in said workflow management application permits users to attend virtual online meetings.

17. The method of claim 1 where in said workflow management application permits users to send and receive email within said workflow management application.

18. The method of claim 1 wherein said real-time access to said workflow management application is secured by lightweight directory access protocol.

19. The method of claim 1 wherein access to said centralized computer database system is based on an entitlement system.

20. The method of claim 1 wherein said workflow management application provides a means for translating said documents into a common language.

21. The method of claim 1 wherein said workflow management application comprises:
means for accessing said document management application;
means for monitoring the progress of said claim management process;
means for performing research pertaining to said claim management process;
means for engaging in real-time collaboration on issues pertaining to said claim management process; and
means for managing said claim management process.

22. The method of claim 21 wherein said means for accessing said document management application comprises secure, encrypted transmission.

23. The method of claim 21 wherein said means for accessing said document management application comprises access over the Internet.

24. The method in claim 21 wherein said means for monitoring said claim management system comprises real-time information pertaining to the status of said documents in said centralized computer database.

25. The method of claim 21 wherein said means for performing research comprises real-time access to said centralized computer database.

26. The method of claim 21 wherein said document management application provides a means for retaining forms commonly used in said claim management process.

27. A system for collaboratively managing an insurance claim comprising:
a centralized remotely-accessible database including documents pertaining to the insurance claim;
an application layer including a workflow management application, a document management application, an administration application and access to said centralized remotely-accessible database; and
means for parties involved in processing said insurance claim to remotely access said application layer.

28. The system of claim 27 wherein said centralized remotely-accessible database is a relational database.

29. The system of claim 27 wherein said documents pertaining to said insurance claim include data on a claim, data on an insured and data on the claim resolution process.

30. The system of claim 27 wherein said centralized remotely-accessible database is remotely accessible within a wide area network.

31. The system of claim 27 further including means for converting said documents into formatted data files for ease of storage and transmission.

32. The system of claim 27 wherein said centralized remotely-accessible database is accessible by secure, encrypted transmission.

33. The system of claim 27 wherein said centralized remotely-accessible database is accessible over the Internet.

34. The system of claim 27 wherein said workflow management application provides a means for electronically signing said documents.

35. The system of claim 27 wherein said workflow management application comprises:
means for accessing said document management application;
means for monitoring the progress of the overall claim management process;
means for performing research pertaining to said claim management process;
means for engaging in real-time collaboration on issues pertaining to said claim management process; and
means for managing said claim management process.

36. The system of claim 35 wherein said means for monitoring the progress of the overall claim management system comprises real-time information pertaining to the status of said documents in said computer database.

37. A method for verifying a projected return on investment comprising:
analyzing the specific business operation of a potential user;
determining the factors relevant to the calculation of said business' return on investment;
calculating the return on investment based on said factors in said business operation;
integrating said calculation into the claim processing system;
monitoring said factors within said claim processing system; and
verifying said calculation on a real-time basis based on the changes to said factors.
